(19) United States
(12) Patent Application Publication
(10) Pub. No.: US 2020/0234574 A1
(43) Pub. Date: Jul. 23, 2020

(54) VEHICLE CONTROL DEVICE INSTALLED IN VEHICLE AND VEHICLE CONTROL METHOD

(71) Applicant: LG Electronics Inc., SEOUL (KR)

(72) Inventors: Suho PARK, Seoul (KR); Hansung KIM, Seoul (KR); Hyunho KI, Seoul (KR); Jaeseung BAE, Seoul (KR); Jaehwan YOON, Seoul (KR)

(21) Appl. No.: 16/489,758

(22) PCT Filed: Jul. 11, 2017
(86) PCT No.: PCT/KR2017/007412

§ 371 Date: Aug. 29, 2019

(30) Foreign Application Priority Data
Jun. 13, 2017 (KR) 10-2017-0074385

(51) Int. Cl. G08G 1/01; G06K 9/00; H04W 4/46; H04W 4/029

(52) U.S. Cl. CPC G08G 1/0145; G08G 1/0133; H04W 4/029; H04W 4/46; G06K 9/00798

(57) ABSTRACT

The present invention relates to a vehicle control device installed in a vehicle and a vehicle control method. The vehicle control device according to an embodiment of the present invention comprises: a communication unit configured to receive position information of the vehicle through a GPS module, and receive, from another vehicle, first position information of the another vehicle through a V2X module; a sensing unit for sensing second position information including a relative position of the vehicle to the another vehicle; and a processor for correcting the received position information of the vehicle on the basis of the first position information received through the communication unit and the second position information sensed by the sensing unit.

### TECHNICAL FIELD

The present invention relates to a vehicle control device installed in a vehicle and a vehicle control method.

### BACKGROUND ART

A vehicle is an apparatus capable of moving a user in the user-desired direction. Typically, a representative example may be a car.

Meanwhile, for convenience of a user using a vehicle, various types of sensors and electronic devices are provided in the vehicle. Specifically, a study on an Advanced Driver Assistance System (ADAS) is actively undergoing. In addition, an autonomous vehicle is actively under development.

A vehicle may be provided with various types of lamps. In general, the vehicle includes various vehicle lamps having a lighting function of facilitating articles or objects near the vehicle to be recognized during driving at night, and a signaling function of notifying a driving state of the vehicle to other vehicles or pedestrians.

For example, the vehicle may include devices operating in a manner of directly emitting light using lamps, such as a head lamp emitting light to a front side to ensure a driver's view, a brake lamp turned on when slamming the brake on, turn indicator lamps used upon a left turn or a right turn.

As another example, reflectors for reflecting light to facilitate the vehicle to be recognized from outside are mounted on front and rear sides of the vehicle.

Installation criteria and standards of the lamps for the vehicle are regulated as rules to fully exhibit each function.

Meanwhile, as the development of the advanced driving assist system (ADAS) is actively undergoing in recent time, development of a technology for optimizing user's convenience and safety while driving a vehicle is required.

As a part of this, in recent years, it is necessary to more accurately position a vehicle for the purpose of ADAS, vehicle-to-everything (V2X) service, and autonomous driving of a vehicle, and the like.

Meanwhile, conventionally, an error range of received GPS information is several meters, and thus, accuracy with respect to positioning of a vehicle is somewhat deteriorated, which is problematic in implementing the ADAS, V2X service, autonomous driving, and the like.

### DISCLOSURE

### Technical Problem

An object of the present invention is to provide a vehicle control device and a vehicle control device and a vehicle control method capable of determining a position of a vehicle by an optimized method.

Another object of the present invention is to provide a vehicle control device and a vehicle control method capable of reducing an error range included in position information of a vehicle.

Still another object of the present invention is to provide a vehicle control device and a vehicle control method capable of reducing an error range of position information of a present vehicle to thereby reduce even position information of another vehicle.

The problems of the present invention are not limited to the problems mentioned above and other problems not mentioned may be clearly understood by those skilled in the art from the following description.

### Technical Solution

In an aspect, a vehicle control device provided in a vehicle according to an embodiment of the present invention includes: a communication unit receiving position information of the vehicle through a GPS module and receiving first position information of another vehicle through a V2X module from the other vehicle; a sensing unit sensing second position information including a relative position between the vehicle and the other vehicle; and a processor correcting the received position information of the vehicle on the basis of the first position information received through the communication unit and the second position information sensed through the sensing unit.

In an embodiment, the position information of the vehicle and the first position information of the other vehicle may each be GPS information and have an error range.

In an embodiment, the error range of the position information of the vehicle may be different from the error range of the first position information of the other vehicle.

In an embodiment, the error range of the position information of the vehicle is larger than the error range of the first position information of the other vehicle.

The second position information sensed through the sensing unit may include distance information between the vehicle and the other vehicle, and angle information at which the other vehicle is located with respect to distance information between the vehicle and the other vehicle and one direction of the vehicle.

In an embodiment, the processor may reduce an error range of the position information of the vehicle using the first position information and the second position information.

In an embodiment, the error range of the position information of the vehicle may be further reduced as the sensed second position information and the number of other vehicles that transmit the first position information increase.

In an embodiment, the processor may reduce the error range of the first position information on the basis of the position information of the vehicle reduced in the error range and the second position information.

In the embodiment, the processor may identify a lane of a road in which the vehicle is running, on the basis of the corrected position information of the vehicle.

In an embodiment, the processor may determine a collision estimated point with the other vehicle on the basis of the corrected vehicle position information and the sensed second position information.

In an embodiment, the first position information of the other vehicle may include at least one of information related to a speed of the other vehicle and information related to an appearance of the other vehicle, and the processor may associate the first position information, the second position information, and the other vehicle on the basis of the information related to the other vehicle sensed through the sensing unit and at least one of the information related to the speed of the other vehicle and information related to an appearance of the other vehicle included in the received first position information of the other vehicle.

In an embodiment, the communication unit may be configured to receive position information of the mobile terminal from at least one mobile terminal existing in the vehicle, and the processor may be configured to correct the position information of the vehicle using the position information received from the at least one mobile terminal through the communication unit and the position information of the vehicle.

In an embodiment, the processor may identify a lane of a road in which the vehicle is running using the sensing unit, and correct the position information of the vehicle on the basis of the identified lane.

In an embodiment of the present invention, the processor may sense relative position information between the present vehicle and a preset object using the sensing unit and correct the position information of the vehicle on the basis of absolute coordinates of the preset object and the relative position information with respect to the preset object.

A vehicle according to an embodiment of the present invention includes the vehicle control device described in this specification.

The details of other embodiments are included in the detailed description and drawings.

### Advantageous Effect

According to an embodiment of the present invention, there is one or more of the following effects.

The present invention may provide a vehicle control device and a vehicle control method capable of reducing an error range of position information of the present vehicle by an optimized method.

In addition, the present invention may provide a new method for obtaining precise position (coordinates) of the present vehicle, which may be applied to ADAS, V2X service, autonomous driving, and the like, while using a low-cost GPS.

In addition, the present invention may provide a new method for further reducing an error range included in position information of the present vehicle as the number of other vehicles around the vehicle increases.

In addition, the present invention may provide a system capable of improving precision of GPS information of the present vehicle on the basis of position information of another vehicle measured by a sensor and the GPS information of other nearby vehicles received through V2X communication.

The effects of the present invention are not limited to the effects mentioned above, and other effects not mentioned may be clearly understood by those skilled in the art from the description of the claims.

### BRIEF DESCRIPTION OF THE DRAWINGS

FIG. 1 is a view illustrating appearance of a vehicle in accordance with an embodiment of the present invention.

FIG. 2 is a view illustrating appearance of a vehicle at various angles in accordance with an embodiment of the present invention.

FIGS. 3 and 4 are views illustrating an inside of a vehicle in accordance with an embodiment of the present invention.

FIGS. 5 and 6 are reference views illustrating objects in accordance with an embodiment of the present invention.

FIG. 7 is a block diagram illustrating a vehicle in accordance with an embodiment of the present invention.

FIG. 8 is a conceptual diagram illustrating a vehicle control device according to an embodiment of the present invention.

FIG. 9 is a flowchart illustrating a typical control method of the present invention.

FIGS. 10, 11, 12, 13, 14, 15, 16, 17, and 18 are conceptual diagrams illustrating the control method shown in FIG. 9.

FIGS. 19 and 20 are conceptual diagrams illustrating a control method for correcting position information of a present vehicle according to another embodiment of the present invention.

### MODES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle according to an embodiment of the present invention may be understood as a conception including cars, motorcycles and the like. Hereinafter, the vehicle will be described based on a car.

The vehicle according to the embodiment of the present invention may be a conception including all of an internal combustion engine car having an engine as a power source, a hybrid vehicle having an engine and an electric motor as power sources, an electric vehicle having an electric motor as a power source, and the like.

In the following description, a left side of a vehicle refers to a left side in a driving direction of the vehicle, and a right side of the vehicle refers to a right side in the driving direction.

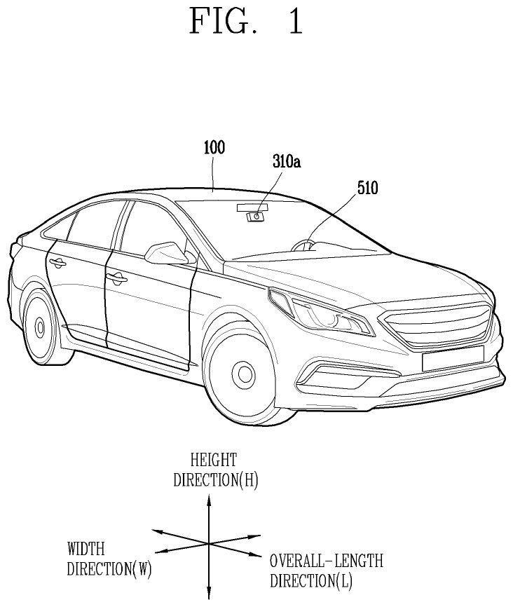

FIG. 1 is a view illustrating appearance of a vehicle in accordance with an embodiment of the present invention.

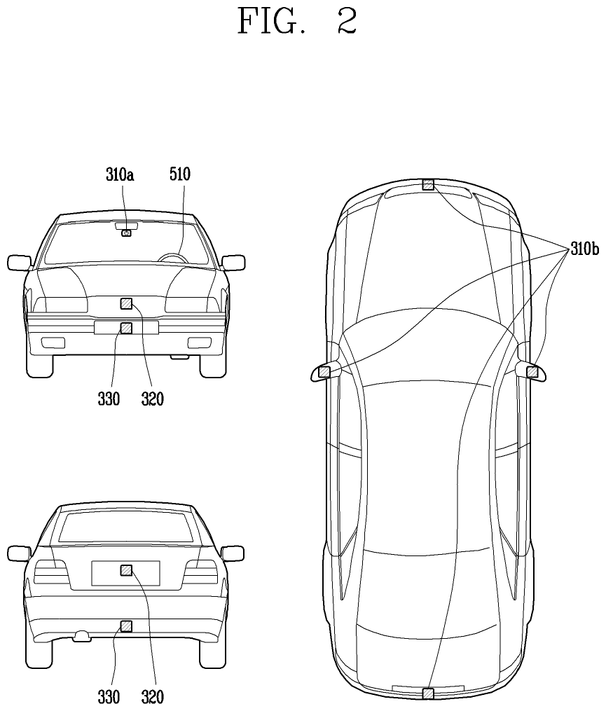

FIG. 2 is a view illustrating appearance of a vehicle at various angles in accordance with an embodiment of the present invention.

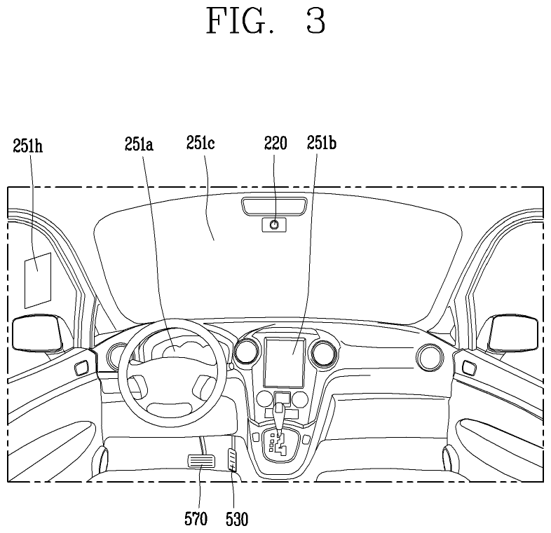

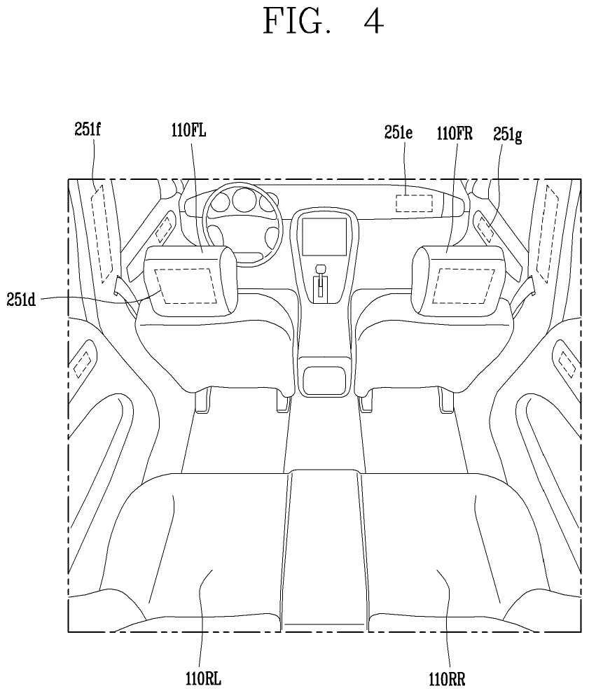

FIGS. 3 and 4 are views illustrating an inside of a vehicle in accordance with an embodiment of the present invention.

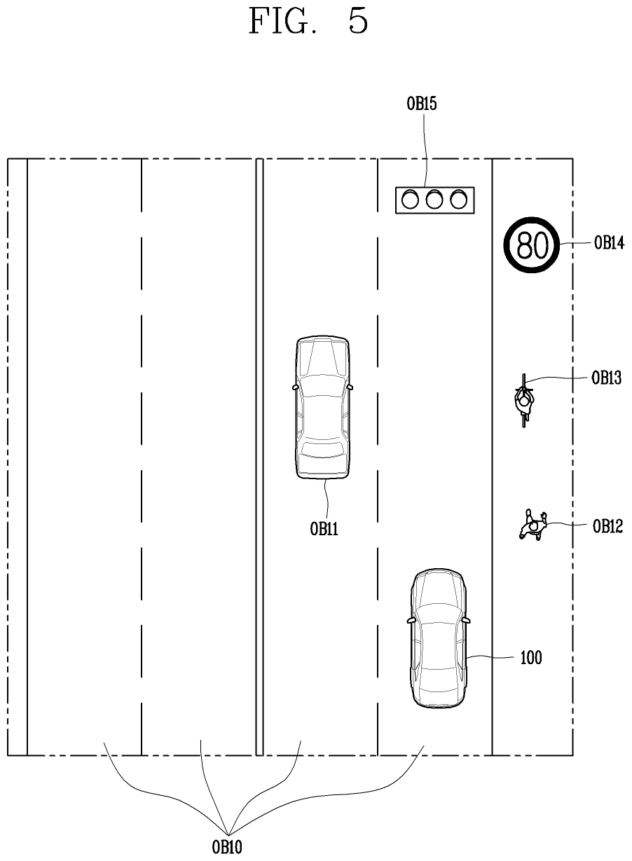

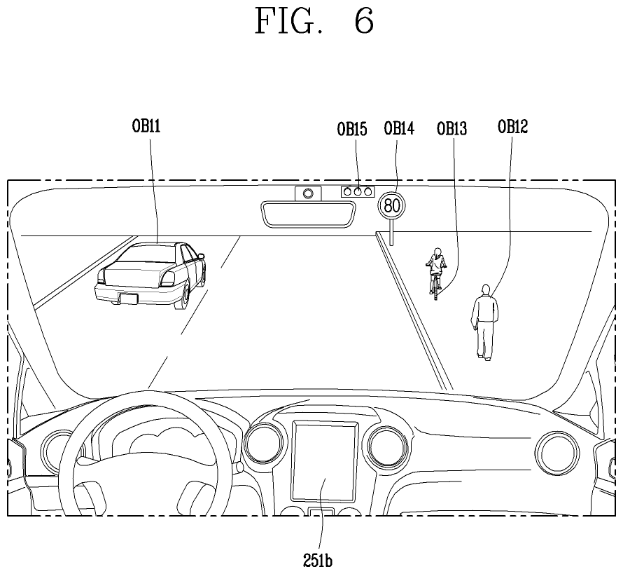

FIGS. 5 and 6 are reference views illustrating objects in accordance with an embodiment of the present invention.

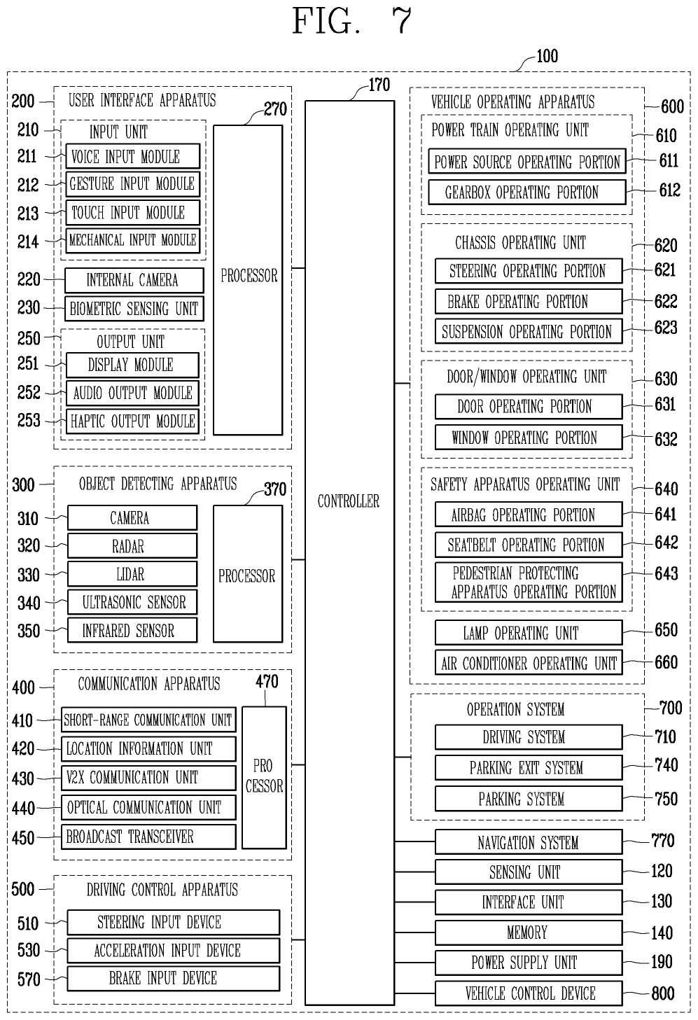

FIG. 7 is a block diagram illustrating a vehicle in accordance with an embodiment of the present invention.

As illustrated in FIGS. 1 to 7, a vehicle 100 may include wheels turning by a driving force, and a steering apparatus 510 for adjusting a driving (ongoing, moving) direction of the vehicle 100.

The vehicle 100 may be an autonomous vehicle.

The vehicle 100 may be switched into an autonomous mode or a manual mode based on a user input.

For example, the vehicle may be converted from the manual mode into the autonomous mode or from the autonomous mode into the manual mode based on a user input received through a user interface apparatus 200.

The vehicle 100 may be switched into the autonomous mode or the manual mode based on driving environment information. The driving environment information may be generated based on object information provided from an object detecting apparatus 300.

For example, the vehicle 100 may be switched from the manual mode into the autonomous mode or from the autonomous module into the manual mode based on driving environment information generated in the object detecting apparatus 300.

In an example, the vehicle 100 may be switched from the manual mode into the autonomous mode or from the autonomous module into the manual mode based on driving environment information received through a communication apparatus 400.

The vehicle 100 may be switched from the manual mode into the autonomous mode or from the autonomous module into the manual mode based on information, data or signal provided from an external device.

When the vehicle 100 is driven in the autonomous mode, the autonomous vehicle 100 may be driven based on an operation system 700.

For example, the autonomous vehicle 100 may be driven based on information, data or signal generated in a driving system 710, a parking exit system 740 and a parking system 750.

When the vehicle 100 is driven in the manual mode, the autonomous vehicle 100 may receive a user input for driving through a driving control apparatus 500. The vehicle 100 may be driven based on the user input received through the driving control apparatus 500.

An overall length refers to a length from a front end to a rear end of the vehicle 100, a width refers to a width of the vehicle 100, and a height refers to a length from a bottom of a wheel to a roof. In the following description, an overall-length direction L may refer to a direction which is a criterion for measuring the overall length of the vehicle 100, a width direction W may refer to a direction that is a criterion for measuring a width of the vehicle 100, and a height direction H may refer to a direction that is a criterion for measuring a height of the vehicle 100.

As illustrated in FIG. 7, the vehicle 100 may include a user interface apparatus 200, an object detecting apparatus 300, a communication apparatus 400, a driving control apparatus 500, a vehicle operating apparatus 600, a operation system 700, a navigation system 770, a sensing unit 120, an interface unit 130, a memory 140, a controller 170 and a power supply unit 190.

According to embodiments, the vehicle 100 may include more components in addition to components to be explained in this specification or may not include some of those components to be explained in this specification.

The user interface apparatus 200 is an apparatus for communication between the vehicle 100 and a user. The user interface apparatus 200 may receive a user input and provide information generated in the vehicle 100 to the user. The vehicle 200 may implement user interfaces (UIs) or user experiences (UXs) through the user interface apparatus 200.

The user interface apparatus 200 may include an input unit 210, an internal camera 220, a biometric sensing unit 230, an output unit 250 and a processor 270.

According to embodiments, the user interface apparatus 200 may include more components in addition to components to be explained in this specification or may not include some of those components to be explained in this specification.

The input unit 200 may allow the user to input information. Data collected in the input unit 120 may be analyzed by the processor 270 and processed as a user's control command.

The input unit 200 may be disposed inside the vehicle. For example, the input unit 200 may be disposed on one area of a steering wheel, one area of an instrument panel, one area of a seat, one area of each pillar, one area of a door, one area of a center console, one area of a headlining, one area of a sun visor, one area of a wind shield, one area of a window or the like.

The input unit 200 may include a voice input module 211, a gesture input module 212, a touch input module 213, and a mechanical input module 214.

The audio input module 211 may convert a user's voice input into an electric signal. The converted electric signal may be provided to the processor 270 or the controller 170.

The voice input module 211 may include at least one microphone.

The gesture input module 212 may convert a user's gesture input into an electric signal. The converted electric signal may be provided to the processor 270 or the controller 170.

The gesture input module 212 may include at least one of an infrared sensor and an image sensor for detecting the user's gesture input.

According to embodiments, the gesture input module 212 may detect a user's three-dimensional (3D) gesture input. To this end, the gesture input module 212 may include a light emitting diode outputting a plurality of infrared rays or a plurality of image sensors.

The gesture input module 212 may detect the user's 3D gesture input by a time of flight (TOF) method, a structured light method or a disparity method.

The touch input module 213 may convert the user's touch input into an electric signal. The converted electric signal may be provided to the processor 270 or the controller 170.

The touch input module 213 may include a touch sensor for detecting the user's touch input.

According to an embodiment, the touch input module 213 may be integrated with the display module 251 so as to implement a touch screen. The touch screen may provide an input interface and an output interface between the vehicle 100 and the user.

The mechanical input module 214 may include at least one of a button, a dome switch, a jog wheel and a jog switch. An electric signal generated by the mechanical input module 214 may be provided to the processor 270 or the controller 170.

The mechanical input module 214 may be arranged on a steering wheel, a center fascia, a center console, a cockpit module, a door and the like.

The internal camera 220 may acquire an internal image of the vehicle. The processor 270 may detect a user's state based on the internal image of the vehicle. The processor 270 may acquire information related to the user's gaze from the internal image of the vehicle. The processor 270 may detect a user gesture from the internal image of the vehicle.

The biometric sensing unit 230 may acquire the user's biometric information. The biometric sensing module 230 may include a sensor for detecting the user's biometric information and acquire fingerprint information and heart rate information regarding the user using the sensor. The biometric information may be used for user authentication.

The output unit 250 may generate an output related to a visual, audible or tactile signal.

The output unit 250 may include at least one of a display module 251, an audio output module 252 and a haptic output module 253.

The display module 251 may output graphic objects corresponding to various types of information.

The display module 251 may include at least one of a liquid crystal display (LCD), a thin film transistor-LCD (TFT LCD), an organic light-emitting diode (OLED), a flexible display, a three-dimensional (3D) display and an e-ink display.

The display module 251 may be inter-layered or integrated with a touch input module 213 to implement a touch screen.

The display module 251 may be implemented as a head up display (HUD). When the display module 251 is implemented as the HUD, the display module 251 may be provided with a projecting module so as to output information through an image which is projected on a windshield or a window.

The display module 251 may include a transparent display. The transparent display may be attached to the windshield or the window.

The transparent display may have a predetermined degree of transparency and output a predetermined screen thereon. The transparent display may include at least one of a thin film electroluminescent (TFEL), a transparent OLED, a transparent LCD, a transmissive transparent display and a transparent LED display. The transparent display may have adjustable transparency.

Meanwhile, the user interface apparatus 200 may include a plurality of display modules 251a to 251g.

The display module 251 may be disposed on one area of a steering wheel, one area 521a, 251b, 251e of an instrument panel, one area 251d of a seat, one area 251f of each pillar, one area 251g of a door, one area of a center console, one area of a headlining or one area of a sun visor, or implemented on one area 251c of a windshield or one area 251h of a window.

The audio output module 252 converts an electric signal provided from the processor 270 or the controller 170 into an audio signal for output. To this end, the audio output module 252 may include at least one speaker.

The haptic output module 253 generates a tactile output. For example, the haptic output module 253 may vibrate the steering wheel, a safety belt, a seat 110FL, 110FR, 110RL, 110RR such that the user can recognize such output.

The processor 270 may control an overall operation of each unit of the user interface apparatus 200.

According to an embodiment, the user interface apparatus 200 may include a plurality of processors 270 or may not include any processor 270.

When the processor 270 is not included in the user interface apparatus 200, the user interface apparatus 200 may operate according to a control of a processor of another apparatus within the vehicle 100 or the controller 170.

Meanwhile, the user interface apparatus 200 may be called as a display apparatus for vehicle.

The user interface apparatus 200 may operate according to the control of the controller 170.

The object detecting apparatus 300 is an apparatus for detecting an object located at outside of the vehicle 100.

The object may be a variety of objects associated with driving (operation) of the vehicle 100.

Referring to FIGS. 5 and 6, an object O may include a traffic lane OB10, another vehicle OB11, a pedestrian OB12, a two-wheeled vehicle OB13, traffic signals OB14 and OB15, light, a road, a structure, a speed hump, a terrain, an animal and the like.

The lane OB01 may be a driving lane, a lane next to the driving lane or a lane on which another vehicle comes in an opposite direction to the vehicle 100. The lanes OB10 may be a concept including left and right lines forming a lane.

The another vehicle OB11 may be a vehicle which is moving around the vehicle 100. The another vehicle OB11 may be a vehicle located within a predetermined distance from the vehicle 100. For example, the another vehicle OB11 may be a vehicle which moves before or after the vehicle 100.

The pedestrian OB12 may be a person located near the vehicle 100. The pedestrian OB12 may be a person located within a predetermined distance from the vehicle 100. For example, the pedestrian OB12 may be a person located on a sidewalk or roadway.

The two-wheeled vehicle OB12 may refer to a vehicle (transportation facility) that is located near the vehicle 100 and moves using two wheels. The two-wheeled vehicle OB12 may be a vehicle that is located within a predetermined distance from the vehicle 100 and has two wheels. For example, the two-wheeled vehicle OB13 may be a motorcycle or a bicycle that is located on a sidewalk or roadway.

The traffic signals may include a traffic light OB15, a traffic sign OB14 and a pattern or text drawn on a road surface.

The light may be light emitted from a lamp provided on another vehicle. The light may be light generated from a streetlamp. The light may be solar light.

The road may include a road surface, a curve, an upward slope, a downward slope and the like.

The structure may be an object that is located near a road and fixed on the ground. For example, the structure may include a streetlamp, a roadside tree, a building, an electric pole, a traffic light, a bridge and the like.

The terrain may include a mountain, a hill and the like.

Meanwhile, objects may be classified into a moving object and a fixed object. For example, the moving object may be a concept including another vehicle and a pedestrian. The fixed object may be a concept including a traffic signal, a road and a structure, for example.

The object detecting apparatus 300 may include a camera 310, a radar 320, a LiDAR 330, an ultrasonic sensor 340, an infrared sensor 350 and a processor 370.

According to an embodiment, the object detecting apparatus 300 may further include other components in addition to the components described, or may not include some of the components described.

The camera 310 may be located on an appropriate portion outside the vehicle to acquire an external image of the vehicle. The camera 310 may be a mono camera, a stereo camera 310a, an around view monitoring (AVM) camera 310b or a 360-degree camera.

For example, the camera 310 may be disposed adjacent to a front windshield within the vehicle to acquire a front image of the vehicle. Or, the camera 310 may be disposed adjacent to a front bumper or a radiator grill.

For example, the camera 310 may be disposed adjacent to a rear glass within the vehicle to acquire a rear image of the vehicle. Or, the camera 310 may be disposed adjacent to a rear bumper, a trunk or a tail gate.

For example, the camera 310 may be disposed adjacent to at least one of side windows within the vehicle to acquire a side image of the vehicle. Or, the camera 310 may be disposed adjacent to a side mirror, a fender or a door.

The camera 310 may provide an acquired image to the processor 370.

The radar 320 may include electric wave transmitting and receiving portions. The radar 320 may be implemented as a pulse radar or a continuous wave radar according to a principle of emitting electric waves. The radar 320 may be implemented in a frequency modulated continuous wave (FMCW) manner or a frequency shift Keyong (FSK) manner according to a signal waveform, among the continuous wave radar methods.

The radar 320 may detect an object in a time of flight (TOF) manner or a phase-shift manner through the medium of the electric wave, and detect a position of the detected object, a distance from the detected object and a relative speed with the detected object.

The radar 320 may be disposed on an appropriate position outside the vehicle for detecting an object which is located at a front, rear or side of the vehicle.

The LiDAR 330 may include laser transmitting and receiving portions. The LiDAR 330 may be implemented in a time of flight (TOF) manner or a phase-shift manner.

The LiDAR 330 may be implemented as a drive type or a non-drive type.

For the drive type, the LiDAR 330 may be rotated by a motor and detect object near the vehicle 100.

For the non-drive type, the LiDAR 330 may detect, through light steering, objects which are located within a predetermined range based on the vehicle 100. The vehicle 100 may include a plurality of non-drive type LiDARs 330.

The LiDAR 330 may detect an object in a TOP manner or a phase-shift manner through the medium of a laser beam, and detect a position of the detected object, a distance from the detected object and a relative speed with the detected object.

The LiDAR 330 may be disposed on an appropriate position outside the vehicle for detecting an object located at the front, rear or side of the vehicle.

The ultrasonic sensor 340 may include ultrasonic wave transmitting and receiving portions. The ultrasonic sensor 340 may detect an object based on an ultrasonic wave, and detect a position of the detected object, a distance from the detected object and a relative speed with the detected object.

The ultrasonic sensor 340 may be disposed on an appropriate position outside the vehicle for detecting an object located at the front, rear or side of the vehicle.

The infrared sensor 350 may include infrared light transmitting and receiving portions. The infrared sensor 340 may detect an object based on infrared light, and detect a position of the detected object, a distance from the detected object and a relative speed with the detected object.

The infrared sensor 350 may be disposed on an appropriate position outside the vehicle for detecting an object located at the front, rear or side of the vehicle.

The processor 370 may control an overall operation of each unit of the object detecting apparatus 300.

The processor 370 may detect an object based on an acquired image, and track the object. The processor 370 may execute operations, such as a calculation of a distance from the object, a calculation of a relative speed with the object and the like, through an image processing algorithm.

The processor 370 may detect an object based on a reflected electromagnetic wave which an emitted electromagnetic wave is reflected from the object, and track the object. The processor 370 may execute operations, such as a calculation of a distance from the object, a calculation of a relative speed with the object and the like, based on the electromagnetic wave.

The processor 370 may detect an object based on a reflected laser beam which an emitted laser beam is reflected from the object, and track the object. The processor 370 may execute operations, such as a calculation of a distance from the object, a calculation of a relative speed with the object and the like, based on the laser beam.

The processor 370 may detect an object based on a reflected ultrasonic wave which an emitted ultrasonic wave is reflected from the object, and track the object. The processor 370 may execute operations, such as a calculation of a distance from the object, a calculation of a relative speed with the object and the like, based on the ultrasonic wave.

The processor may detect an object based on reflected infrared light which emitted infrared light is reflected from the object, and track the object. The processor 370 may execute operations, such as a calculation of a distance from the object, a calculation of a relative speed with the object and the like, based on the infrared light.

According to an embodiment, the object detecting apparatus 300 may include a plurality of processors 370 or may not include any processor 370. For example, each of the camera 310, the radar 320, the LiDAR 330, the ultrasonic sensor 340 and the infrared sensor 350 may include the processor in an individual manner.

When the processor 370 is not included in the object detecting apparatus 300, the object detecting apparatus 300 may operate according to the control of a processor of an apparatus within the vehicle 100 or the controller 170.

The object detecting apparatus 400 may operate according to the control of the controller 170.

The communication apparatus 400 is an apparatus for performing communication with an external device. Here, the external device may be another vehicle, a mobile terminal or a server.

The communication apparatus 400 may perform the communication by including at least one of a transmitting antenna, a receiving antenna, and radio frequency (RF) circuit and RF device for implementing various communication protocols.

The communication apparatus 400 may include a short-range communication unit 410, a location information unit 420, a V2X communication unit 430, an optical communication unit 440, a broadcast transceiver 450 and a processor 470.

According to an embodiment, the communication apparatus 400 may further include other components in addition to the components described, or may not include some of the components described.

The short-range communication unit 410 is a unit for facilitating short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication unit 410 may construct short-range area networks to perform short-range communication between the vehicle 100 and at least one external device.

The location information unit 420 is a unit for acquiring position information. For example, the location information unit 420 may include a Global Positioning System (GPS) module or a Differential Global Positioning System (DGPS) module.

The V2X communication unit 430 is a unit for performing wireless communications with a server (Vehicle to Infra; V2I), another vehicle (Vehicle to Vehicle; V2V), or a pedestrian (Vehicle to Pedestrian; V2P). The V2X communication unit 430 may include an RF circuit implementing a communication protocol with the infra (V2I), a communication protocol between the vehicles (V2V) and a communication protocol with a pedestrian (V2P).

The optical communication unit 440 is a unit for performing communication with an external device through the medium of light. The optical communication unit 440 may include a light-emitting diode for converting an electric signal into an optical signal and sending the optical signal to the exterior, and a photodiode for converting the received optical signal into an electric signal.

According to an embodiment, the light-emitting diode may be integrated with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel may include a satellite channel, a terrestrial channel, or both. The broadcast signal may include a TV broadcast signal, a radio broadcast signal and a data broadcast signal.

The processor 470 may control an overall operation of each unit of the communication apparatus 400.

According to an embodiment, the communication apparatus 400 may include a plurality of processors 470 or may not include any processor 470.

When the processor 470 is not included in the communication apparatus 400, the communication apparatus 400 may operate according to the control of a processor of another device within the vehicle 100 or the controller 170.

Meanwhile, the communication apparatus 400 may implement a display apparatus for a vehicle together with the user interface apparatus 200. In this instance, the display apparatus for the vehicle may be referred to as a telematics apparatus or an Audio Video Navigation (AVN) apparatus.

The communication apparatus 400 may operate according to the control of the controller 170.

The driving control apparatus 500 is an apparatus for receiving a user input for driving.

In a manual mode, the vehicle 100 may be operated based on a signal provided by the driving control apparatus 500.

The driving control apparatus 500 may include a steering input device 510, an acceleration input device 530 and a brake input device 570.

The steering input device 510 may receive an input regarding a driving (ongoing) direction of the vehicle 100 from the user. The steering input device 510 is preferably configured in the form of a wheel allowing a steering input in a rotating manner. According to some embodiments, the steering input device may also be configured in a shape of a touch screen, a touch pad or a button.

The acceleration input device 530 may receive an input for accelerating the vehicle 100 from the user. The brake input device 570 may receive an input for braking the vehicle 100 from the user. Each of the acceleration input device 530 and the brake input device 570 is preferably configured in the form of a pedal. According to some embodiments, the acceleration input device or the brake input device may also be configured in a shape of a touch screen, a touch pad or a button.

The driving control apparatus 500 may operate according to the control of the controller 170.

The vehicle operating apparatus 600 is an apparatus for electrically controlling operations of various devices within the vehicle 100.

The vehicle operating apparatus 600 may include a power train operating unit 610, a chassis operating unit 620, a door/window operating unit 630, a safety apparatus operating unit 640, a lamp operating unit 650, and an air-conditioner operating unit 660.

According to some embodiments, the vehicle operating apparatus 600 may further include other components in addition to the components described, or may not include some of the components described.

Meanwhile, the vehicle operating apparatus 600 may include a processor. Each unit of the vehicle operating apparatus 600 may individually include a processor.

The power train operating unit 610 may control an operation of a power train device.

The power train operating unit 610 may include a power source operating portion 611 and a gearbox operating portion 612.

The power source operating portion 611 may perform a control for a power source of the vehicle 100.

For example, upon using a fossil fuel-based engine as the power source, the power source operating portion 611 may perform an electronic control for the engine. Accordingly, an output torque and the like of the engine can be controlled. The power source operating portion 611 may adjust the engine output torque according to the control of the controller 170.

For example, upon using an electric energy-based motor as the power source, the power source operating portion 611 may perform a control for the motor. The power source operating portion 611 may adjust a rotating speed, a torque and the like of the motor according to the control of the controller 170.

The gearbox operating portion 612 may perform a control for a gearbox.

The gearbox operating portion 612 may adjust a state of the gearbox. The gearbox operating portion 612 may change the state of the gearbox into drive (forward) (D), reverse (R), neutral (N) or parking (P).

Meanwhile, when an engine is the power source, the gearbox operating portion 612 may adjust a locked state of a gear in the drive (D) state.

The chassis operating unit 620 may control an operation of a chassis device.

The chassis operating unit 620 may include a steering operating portion 621, a brake operating portion 622 and a suspension operating portion 623.

The steering operating portion 621 may perform an electronic control for a steering apparatus within the vehicle 100. The steering operating portion 621 may change a driving direction of the vehicle.

The brake operating portion 622 may perform an electronic control for a brake apparatus within the vehicle 100. For example, the brake operating portion 622 may control an operation of brakes provided at wheels to reduce speed of the vehicle 100.

Meanwhile, the brake operating portion 622 may individually control each of a plurality of brakes. The brake operating portion 622 may differently control braking force applied to each of a plurality of wheels.

The suspension operating portion 623 may perform an electronic control for a suspension apparatus within the vehicle 100. For example, the suspension operating portion 623 may control the suspension apparatus to reduce vibration of the vehicle 100 when a bump is present on a road.

Meanwhile, the suspension operating portion 623 may individually control each of a plurality of suspensions.

The door/window operating unit 630 may perform an electronic control for a door apparatus or a window apparatus within the vehicle 100.

The door/window operating unit 630 may include a door operating portion 631 and a window operating portion 632.

The door operating portion 631 may perform the control for the door apparatus. The door operating portion 631 may control opening or closing of a plurality of doors of the vehicle 100. The door operating portion 631 may control opening or closing of a trunk or a tail gate. The door operating portion 631 may control opening or closing of a sunroof.

The window operating portion 632 may perform the electronic control for the window apparatus. The window operating portion 632 may control opening or closing of a plurality of windows of the vehicle 100.

The safety apparatus operating unit 640 may perform an electronic control for various safety apparatuses within the vehicle 100.

The safety apparatus operating unit 640 may include an airbag operating portion 641, a seatbelt operating portion 642 and a pedestrian protecting apparatus operating portion 643.

The airbag operating portion 641 may perform an electronic control for an airbag apparatus within the vehicle 100. For example, the airbag operating portion 641 may control the airbag to be deployed upon a detection of a risk.

The seatbelt operating portion 642 may perform an electronic control for a seatbelt apparatus within the vehicle 100. For example, the seatbelt operating portion 642 may control passengers to be motionlessly seated in seats 110FL, 110FR, 110RL, 110RR using seatbelts upon a detection of a risk.

The pedestrian protecting apparatus operating portion 643 may perform an electronic control for a hood lift and a pedestrian airbag. For example, the pedestrian protecting apparatus operating portion 643 may control the hood lift and the pedestrian airbag to be open up upon detecting pedestrian collision.

The lamp operating unit 650 may perform an electronic control for various lamp apparatuses within the vehicle 100.

The air-conditioner operating unit 660 may perform an electronic control for an air conditioner within the vehicle 100. For example, the air-conditioner operating unit 660 may control the air conditioner to supply cold air into the vehicle when internal temperature of the vehicle is high.

The vehicle operating apparatus 600 may include a processor. Each unit of the vehicle operating apparatus 600 may individually include a processor.

The vehicle operating apparatus 600 may operate according to the control of the controller 170.

The operation system 700 is a system that controls various driving modes of the vehicle 100. The operation system 700 may operate in an autonomous driving mode.

The operation system 700 may include a driving system 710, a parking exit system 740 and a parking system 750.

According to embodiments, the operation system 700 may further include other components in addition to components to be described, or may not include some of the components to be described.

Meanwhile, the operation system 700 may include a processor. Each unit of the operation system 700 may individually include a processor.

According to embodiments, the operation system may be a sub concept of the controller 170 when it is implemented in a software configuration.

Meanwhile, according to embodiment, the operation system 700 may be a concept including at least one of the user interface apparatus 200, the object detecting apparatus 300, the communication apparatus 400, the vehicle operating apparatus 600 and the controller 170.

The driving system 710 may perform driving of the vehicle 100.

The driving system 710 may receive navigation information from a navigation system 770, transmit a control signal to the vehicle operating apparatus 600, and perform driving of the vehicle 100.

The driving system 710 may receive object information from the object detecting apparatus 300, transmit a control signal to the vehicle operating apparatus 600 and perform driving of the vehicle 100.

The driving system 710 may receive a signal from an external device through the communication apparatus 400, transmit a control signal to the vehicle operating apparatus 600, and perform driving of the vehicle 100.

The parking exit system 740 may perform an exit of the vehicle 100 from a parking lot.

The parking exit system 740 may receive navigation information from the navigation system 770, transmit a control signal to the vehicle operating apparatus 600, and perform the exit of the vehicle 100 from the parking lot.

The parking exit system 740 may receive object information from the object detecting apparatus 300, transmit a control signal to the vehicle operating apparatus 600 and perform the exit of the vehicle 100 from the parking lot.

The parking exit system 740 may receive a signal from an external device through the communication apparatus 400, transmit a control signal to the vehicle operating apparatus 600, and perform the exit of the vehicle 100 from the parking lot.

The parking system 750 may perform parking of the vehicle 100.

The parking system 750 may receive navigation information from the navigation system 770, transmit a control signal to the vehicle operating apparatus 600, and park the vehicle 100.

The parking system 750 may receive object information from the object detecting apparatus 300, transmit a control signal to the vehicle operating apparatus 600 and park the vehicle 100.

The parking system 750 may receive a signal from an external device through the communication apparatus 400, transmit a control signal to the vehicle operating apparatus 600, and park the vehicle 100.

The navigation system 770 may provide navigation information. The navigation information may include at least one of map information, information regarding a set destination, path information according to the set destination, information regarding various objects on a path, lane information and current location information of the vehicle.

The navigation system 770 may include a memory and a processor. The memory may store the navigation information. The processor may control an operation of the navigation system 770.

According to embodiments, the navigation system 770 may update prestored information by receiving information from an external device through the communication apparatus 400.

According to embodiments, the navigation system 770 may be classified as a sub component of the user interface apparatus 200.

The sensing unit 120 may sense a status of the vehicle. The sensing unit 120 may include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 may acquire sensing signals with respect to vehicle-related information, such as a posture, a collision, an orientation, a position (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal and the like.

The sensing unit 120 may further include an accelerator sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The interface unit 130 may serve as a path allowing the vehicle 100 to interface with various types of external devices connected thereto. For example, the interface unit 130 may be provided with a port connectable with a mobile terminal, and connected to the mobile terminal through the port. In this instance, the interface unit 130 may exchange data with the mobile terminal.

Meanwhile, the interface unit 130 may serve as a path for supplying electric energy to the connected mobile terminal. When the mobile terminal is electrically connected to the interface unit 130, the interface unit 130 supplies electric energy supplied from a power supply unit 190 to the mobile terminal according to the control of the controller 170.

The memory 140 is electrically connected to the controller 170. The memory 140 may store basic data for units, control data for controlling operations of units and input/output data. The memory 140 may be a variety of storage devices, such as ROM, RAM, EPROM, a flash drive, a hard drive and the like in a hardware configuration. The memory 140 may store various data for overall operations of the vehicle 100, such as programs for processing or controlling the controller 170.

According to embodiments, the memory 140 may be integrated with the controller 170 or implemented as a sub component of the controller 170.

The controller 170 may control an overall operation of each unit of the vehicle 100. The controller 170 may be referred to as an Electronic Control Unit (ECU).

The power supply unit 190 may supply power required for an operation of each component according to the control of the controller 170. Specifically, the power supply unit 190 may receive power supplied from an internal battery of the vehicle, and the like.

At least one processor and the controller 170 included in the vehicle 100 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

Meanwhile, the vehicle 100 according to the present invention may include a vehicle control device 800.

The vehicle control device 800 may control at least one of those components illustrated in FIG. 7. From this perspective, the vehicle control device 800 may be the controller 170.

Without a limit to this, the vehicle control device 800 may be a separate device, independent of the controller 170. When the vehicle control device 800 is implemented as a component independent of the controller 170, the vehicle control device 800 may be provided on a part of the vehicle 100.

Hereinafter, description will be given of an example that the vehicle control device 800 is a component separate from the controller 170 for the sake of explanation. In this specification, functions (operations) and control methods described in relation to the vehicle control device 800 may be executed by the controller 170 of the vehicle. That is, every detail described in relation to the vehicle control device 800 may be applied to the controller 170 in the same/like manner.

Also, the vehicle control device 800 described herein may include some of the components illustrated in FIG. 7 and various components included in the vehicle. For the sake of explanation, the components illustrated in FIG. 7 and the various components included in the vehicle will be described with separate names and reference numbers.

Hereinafter, description will be given in more detail of a method of autonomously driving a vehicle related to the present invention in an optimized manner or outputting warning messages related to driving of the vehicle in an optimized state, with reference to the accompanying drawings.

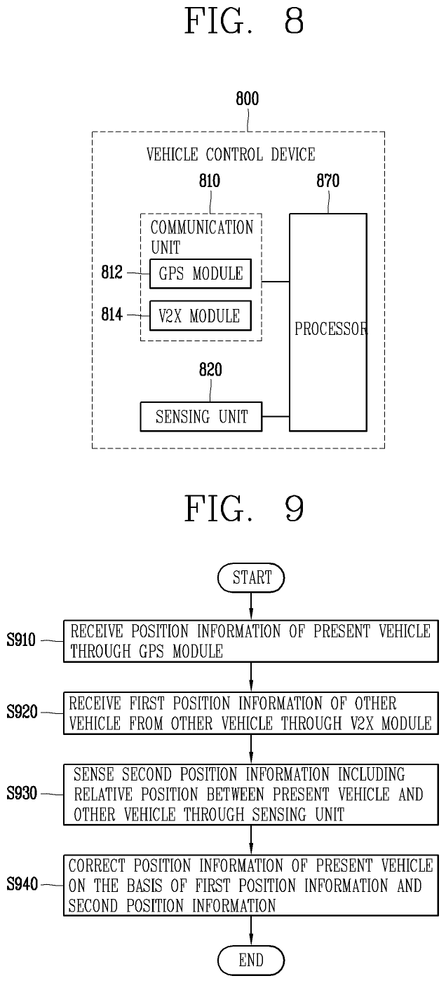

FIG. 8 is a conceptual diagram illustrating a vehicle control device according to an embodiment of the present invention.

The vehicle control device 800 related to the present invention may include a communication unit 810, a sensing unit 820, and a processor 870.

The communication unit 810 may be the communication device 400 described above. The vehicle control device 800 of the present invention may receive (determine) position information of the present vehicle 100 through the communication unit 810. The vehicle control device 800 of the present invention may receive first position information (GPS information of another vehicle) of another vehicle from another vehicle through the communication unit 810.

Referring to FIG. 8, the communication unit 810 included in the vehicle control device 800 related to the present invention may include a GPS module 812, a V2X module 814, and the like.

The GPS module 812 may be the position information unit 420 described above with reference to FIG. 7. Also, the GPS module 812 may perform an operation/function of the position information unit 420. For example, the GPS module 812 may receive (determine) current position information of the vehicle 100. That is, the communication unit 810 related to the present invention may receive the position information of the vehicle 100 through the GPS module 812.

Meanwhile, the V2X module 814 may perform communication with a communicable device. For example, the V2X module 814 may communicate with a nearby vehicle (or other vehicle) or may communicate with an external server (e.g., a cloud server).

In the present specification, a vehicle existing within a communicable distance through the V2X module 814 of the vehicle may be referred to as another vehicle and may be variously expressed as another vehicle existing within a predetermined distance from the present vehicle, a nearby vehicle, or the like. The predetermined distance refers to a distance at which the present vehicle and the other vehicle may perform V2X communication and may be determined or varied depending on performance of the V2X module, a surrounding environment, a communication state, a user setting, and the like.

More specifically, the V2X module 814 (V2X communication) may perform communication with all communicable devices (for example, a mobile terminal, a server, a vehicle, an infrastructure, etc.). This may be named as vehicle to everything (V2X) communication.

The V2X module 814 may perform V2X communication with the other vehicle.

That is, the communication unit 810 may perform communication with the nearby vehicle (or the other vehicle). This may be named V2V (vehicle to vehicle) communication. V2V communication may be generally defined as a technology for exchanging information between vehicles, and it is possible to share a position, speed information, and the like of the other nearby vehicle.

V2I communication may be generally defined as a technology for exchanging or sharing information such as traffic situation, while communicating with an infrastructure (for example, road side unit (RSU)) installed on the road during driving.

V2P communication may be generally defined as a technology of exchanging or sharing information such as vehicle information, vehicle periphery information, and vehicle driving information, while communicating with a mobile terminal possessed by a vehicle and a user (e.g., a pedestrian).

In addition, the communication unit 810 may perform communication with all devices (e.g., mobile terminals, servers, etc.) capable of performing communication This may be named vehicle to everything (V2X) communication. V2X communication may be generally defined as a technology that exchanges information such as traffic situation, while communicating with road infrastructure and another vehicle during driving.

V2V communication may be understood as an example of V2X communication or as a concept included in V2X communication.

The processor 870 may perform V2V communication with a nearby vehicle (another vehicle) through (using) the communication unit 810.

Here, the nearby vehicle may refer to at least one of a vehicle existing within a predetermined distance from the vehicle 100 or a vehicle entering a predetermined distance on the basis of the vehicle 100.

The nearby vehicle may include all vehicles capable of communicating with the communication unit 810 of the vehicle 100. In this specification, for convenience of explanation, it is assumed that the nearby vehicle exists within a predetermined distance from the vehicle 100 or the vehicle enters the predetermined distance.

The predetermined distance may be determined on the basis of a distance that may be communicated through the communication unit 810, or may be determined according to specifications of the product, or may be determined/varied on the basis of a user's setting or V2X communication standard.

Specifically, the V2X module 820 may be configured to receive LDM data from the other vehicle. The LDM data may be V2X messages (BSM, CAM, DENM, etc.) transmitted and received between vehicles via V2X communication.

The LDM data may include position information of the other vehicle.

The processor 870 may determine a relative position between the present vehicle and the other vehicle on the basis of the position information of the present vehicle obtained through the communication unit 810 and the position information of the other vehicle included in the LDM data received via the V2X module 814.

Also, the LDM data may include speed information of the other vehicle. The processor 870 may also determine a relative speed of the other vehicle using the speed information of the present vehicle and the speed information of the other vehicle. The speed information of the vehicle may be calculated using the degree to which the position information of the vehicle received through the communication unit 810 is changed over time or may be calculated on the basis of information received from the driving operation device 500 or the powertrain driving unit 610 of the vehicle 100.

The V2X module 814 may be the V2X communication unit 430 described above.

The V2X module 814 may receive first position information of the other vehicle received (acquired) via the GPS module (GPS module of the other vehicle) mounted on the other vehicle from the other vehicle existing within a predetermined distance from the vehicle. That is, the first position information of the other vehicle may refer to GPS information of the other vehicle obtained from the other vehicle.

Specifically, the GPS module may be mounted not only on the present vehicle but also on the other vehicle. The other vehicle may receive its own position information (i.e., the first position information of the other vehicle in the case of the present vehicle) through the GPS module provided in the other vehicle.

The communication unit 810 of the vehicle control device 800 may receive the first position information of the other vehicle obtained from the other vehicle, through V2X communication through the V2X module 814.

That is, the communication unit 810 related to the present invention may be configured to acquire the position information of the vehicle through the GPS module 812 and receive the first position information of the other vehicle from the other vehicle through the V2X module 814.

Meanwhile, the vehicle control device 800 related to the present invention may include a sensing unit 820.

The sensing unit 820 may be the object detection device 300 described with reference to FIG. 7 or the sensing unit 120 provided in the vehicle 100.

In addition, as for the sensing unit 820, the object detection device 300 or the sensing unit 120 provided in the vehicle 100 may be an independent sensing unit. Even if the sensing unit 820 is an independent sensing unit, the sensing unit 820 may include the characteristics of the sensing unit 120 or the object detection device 300 described with reference to FIG. 7.

The sensing unit 820 may include the camera 310 described with reference to FIG. 7.

The sensing unit 820 may be implemented by combining at least two of a camera 310, a radar 320, a lidar 330, an ultrasonic sensor 340, an infrared sensor 350, a sensing unit 350.

The sensing unit 820 may sense an object existing in the vicinity of the present vehicle 100 and sense information related to the object.

For example, the object may include the surrounding vehicle, surrounding people, surrounding objects, surrounding geographical features, and the like.

The sensing unit 820 may sense information related to the vehicle 100 of the present invention.

The information related to the vehicle may be at least one of vehicle information (or a traveling state of the vehicle) and the peripheral information of the vehicle.

For example, the vehicle information may include a driving speed of the vehicle, a weight of the vehicle, the number of occupants in the vehicle, braking power of the vehicle, maximum braking power of the vehicle, a traveling mode of the vehicle (whether the vehicle is in an autonomous driving mode or a manual driving mode), a parking mode of the vehicle (autonomous parking mode, autonomic parking mode, manual parking mode), whether a user is present within the vehicle, information related to a user (for example, whether the user is an authenticated user), and the like.

The surrounding information of the vehicle may include, for example, a state (frictional force) of a road surface on which the vehicle is driving, weather, a distance to a preceding vehicle (or subsequent vehicle), a relative speed of a preceding vehicle (or a subsequent vehicle), position information of the other vehicle, position information of an object, a bending modulus of a curve when a lane in which the vehicle is driving is a curve, brightness around the vehicle, information related to an object present within a reference region (predetermined region) with respect to the vehicle, whether an object enters/leaves the predetermined region, whether a user is present in the vicinity of the vehicle, information related to the user (e.g., whether the user is an authenticated user or not), and the like.

The surrounding information (or the surrounding environment information) of the vehicle may include external information of the vehicle (for example, surrounding brightness, a temperature, a position of the sun, a surrounding subject (person, another vehicle, signboard, etc.), a type of a road surface on which the vehicle is driving, a geographic feature, line information, traveling lane information), and information required for autonomous driving/autonomous parking/automatic parking/manual parking mode.

In addition, the surrounding information of the vehicle may further include a distance between an object present in the vicinity of the vehicle and the vehicle 100, a type of the object, a parking space in which the vehicle may park, an object (e.g., a parking line, a string, another vehicle, a wall, etc.) for identifying the parking space, and the like.

The sensing unit 820 may sense second position information including a relative position between the present vehicle 100 and the other vehicle. Specifically, the second position information may be information on a relative position (e.g., distance, angle) between the present vehicle 100 and the other vehicle.

That is, the second position information may indicate the position of the other vehicle sensed through the sensing unit 820, and may refer to the position of the other vehicle measured on the basis of the present vehicle.

Since the second position information is not the position information received through the GPS module (for example, the GPS module of the other vehicle) but the position information of the other vehicle measured through the sensing unit 820 in the present vehicle, an error range may be as small as to be neglectable.

Accordingly, the second position information may refer to an absolute position (or absolute coordinates) of the other vehicle with respect to the present vehicle.

Since the second position information is position information of the other vehicle measured through the sensing unit 820 rather than the communication unit 810, the second position information may be referred to as second position information of the other vehicle so as to be distinguished from the first position information of the other vehicle.

Since the second position information includes the meaning of absolute coordinates measured through the sensing unit 820, it is assumed that there is no error range.

A detailed description of the sensing unit 820 and a method of sensing the second position information of the other vehicle will be described in more detail with reference to FIGS. 9 to 11.

Hereinafter, for the sake of convenience of explanation, a case where the sensing unit 820 is separately provided in the vehicle control device 800 will be described as an example. Obtaining certain information through the sensing unit 820 by the processor 870 may be understood as obtaining certain information by the processor 870 using at least one of the object detection device 300 and the sensing unit 120 provided in the vehicle 100.

The vehicle control device 800 of the present invention may include a processor 870 capable of controlling the communication unit 810 and the sensing unit 820 and the like.

The processor 870 may be the controller 170 described with reference to FIG. 7.

The processor 870 may control the components described in FIG. 7 and the components described in FIG. 8.

The processor 870 may autonomously drive the vehicle 100.

For example, the processor 870 may autonomously drive the vehicle 100 on the basis of the information sensed through the sensing unit 820 and the information received through the communication unit 810.

The technology for autonomously driving the vehicle is a general technique, and a detailed description thereof will be omitted.

The processor 870 may correct the position information of the present vehicle received through the communication unit 810 (GPS module 812) on the basis of the position information of the present vehicle 100 received through the communication unit 810, the first position information of the other vehicle, and the second position information of the other vehicle sensed through the sensing unit 820.

Hereinafter, a method of correcting position information of the present vehicle received through the GPS module will be described in more detail with reference to the accompanying drawings.

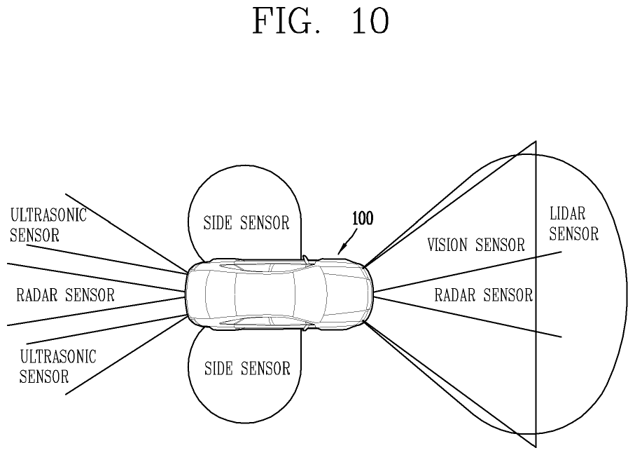

FIG. 9 is a flowchart illustrating a typical control method of the present invention, and FIGS. 10, 11, 12, 13, 14, 15, 16, 17, and 18 are conceptual diagrams for explaining the control method described in FIG. 9.

Referring to FIG. 9, in the present invention, position information of the vehicle is received through the GPS module 812 (S910). Specifically, the processor 870 may receive position information of the present vehicle 100 by controlling (using or utilizing) the communication unit 810 (or the GPS module 812).

The vehicle control device 800 (or the vehicle 100) may acquire a position of the mobile terminal by using a signal sent from a GPS satellite by using the GPS module 812.

The GPS module 812 included in the vehicle control device may detect, calculate, or identify the position of the vehicle 100.

The GPS module 812 calculates distance information from three or more satellites and accurate time information and then applies trigonometry to the calculated information to accurately calculate three-dimensional current position information according to latitude, longitude, and altitude.

The satellite helps locate the vehicle 100. Useful position information may be obtained by two or more satellites.

Currently, position and time information may be calculated using three satellites, and an error of the calculated position and time information may be corrected using another satellite.

Further, the GPS module 812 may calculate speed information by continuously calculating the current position in real time. However, it is difficult to accurately measure the position of the vehicle using the GPS module in a shadow area of a satellite signal, such as an indoor space. Accordingly, a WPS (Wi-Fi Positioning System) may be utilized to compensate for the positioning of the GPS system.

Further, the present invention may utilize the position information of the other vehicle to compensate for the GPS-based positioning.

To this end, in the present invention, first position information of the other vehicle is received from the other vehicle through the V2X module 814 (S920).

Specifically, the processor 870 may perform communication with the other vehicle present existing within a predetermined distance (or capable of performing V2X communication). Specifically, the present vehicle and the other vehicle may periodically transmit and receive a beacon message (basic safety message (BSM) in North America and contextual awareness message (CAM) in Europe). In this case, for example, the present vehicle and the other vehicle may transmit/receive the beacon information at a period of 100 ms in accordance with a V2X communication standard.

The beacon information may include position information of each vehicle (i.e., GPS information) of each vehicle. In this case, the position information of each vehicle (the position information of the present vehicle and the first position information of the other vehicle) included in the beacon information are information obtained through the GPS module, and thus may have an error range.

At this time, the processor 870 may receive the first position information of the other vehicle (i.e., the GPS information of the other vehicle received (obtained and determined) by the GPS module provided in the other vehicle) through the V2X module 814.

Since the position information of the present vehicle and the first position information of the other vehicle are GPS information, they have an error range. In general, the error range of the GPS module may have a radius of several meters to several tens of meters, and the error range may increase as communication with the satellite is not smooth in a nearby high-rise building, a tunnel, a basement, inside a building, and the like.

The other vehicle may receive (acquire) the first position information of the other vehicle through the GPS module provided in the other vehicle. Thereafter, when V2X communication with the vehicle is performed, the other vehicle may transmit the received first position information of the other vehicle to the present vehicle through V2X communication. Accordingly, the processor 870 of the vehicle control device 800 may receive the first position information of the other vehicle from the other vehicle via the V2X module 814.

Thereafter, in the present invention, second position information including a relative position between the present vehicle and the other vehicle is sensed through the sensing unit 820 (S930).

The processor 870 may sense a relative position between the present vehicle and the other vehicle through the sensing unit 820. The relative position between the present vehicle and the other vehicle may include a distance to the other vehicle with respect to the present vehicle 100, an angle at which the other vehicle exists with respect to one axis (for example, axis corresponding to a front direction) of the present vehicle, and the like.

Referring to FIG. 10, the sensing unit 820 may sense a relative position between the present vehicle and the other vehicle using various sensors. The sensor used to sense the relative position may include a vision sensor, a radar sensor, a lidar sensor, a side sensor, an ultrasonic sensor, and the like as shown in FIG. 10. These sensors may be included in the sensing unit 820.

The sensing unit 820 may sense the second position information of the other vehicle (i.e., the second position information including the relative position between the present vehicle and the other vehicle) through any one of the various sensors described above or a combination of at least two sensors thereof.

The vision sensor may be, for example, a camera. The processor 870 may analyze an image received through the vision sensor to extract (detect, determine, and sense) a relative position between the other vehicle and the present vehicle photographed by the vision sensor.

An error of the ultrasonic sensor may be about 50 mm, and a measurable distance may be about 5 m.

An error of the lidar sensor is about 0.2 m, and a measurable distance may be about 200 m.

An error of the radar sensor may be about 0.2 m, and a measurable distance may be about 500 m.

As described above, the errors of the above sensors are quite accurate to within 0.2 m. Meanwhile, an error of the GPS information obtained through the GPS module may be about 2.5 to 10 m. Further, when the error (or error range) is within 0.2 m, it is possible to sense the present vehicle and the other vehicle by lanes.

Accordingly, the second position information of the other vehicle sensed through the sensing unit 820 may be accurate enough to ignore the error. Therefore, the second position information of the other vehicle may be utilized as an absolute position of the other vehicle.

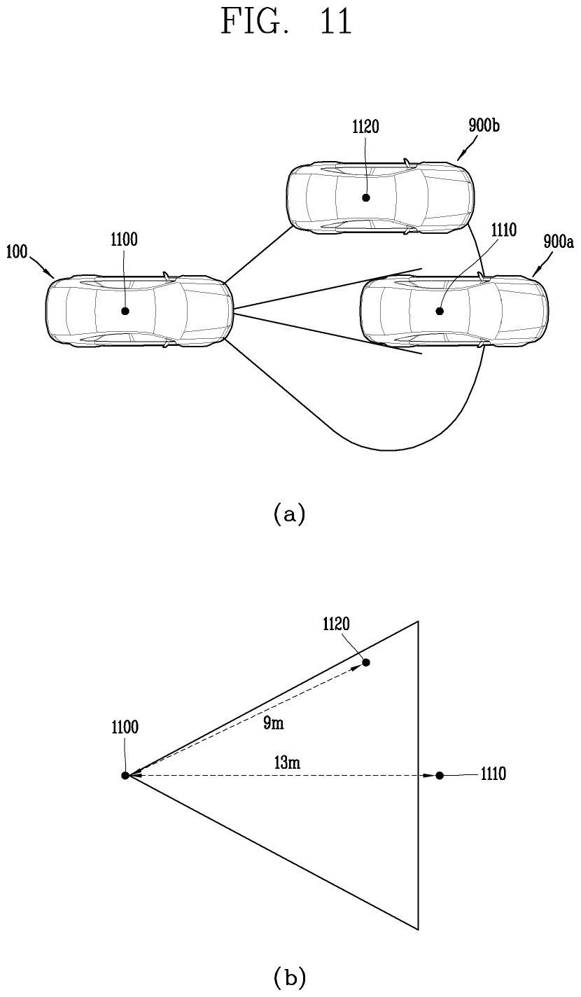

Referring to (a) of FIG. 11, the processor 870 of the present invention may sense the second position information of the other vehicle using the sensing unit 820.

For example, the processor 870 may sense the other vehicles 900a and 900b through the sensing unit 820. The processor 870 may determine the relative position between the vehicle 100 and the sensed other vehicles 900a and 900b.

For example, the processor 870 may determine one point 1100 of the present vehicle 100 and one points 1110 and 1120 of the other vehicles 900a and 900b. Thereafter, as shown in (b) of FIG. 11, the processor 870 may sense distances and angles between the points 1100, 1110, and 1120.

For example, as shown in (b) of FIG. 11, the processor 870 may sense distances (e.g., 13 m and 9 m) to the one points 1110 and 1120 of the other vehicles 900a and 900b with respect to the one point 1100 of the present vehicle 100 and angles (e.g., 0 degree and 30 degrees).

The processor 870 may sense second position information of the other vehicles (i.e., second position information including relative positions between the present vehicle and the other vehicles) on the basis of distances and angles between the one point 1110 of the present vehicle 100 and the points 1110 and 1120 of the other vehicles 900a and 900b.

The positions of the points 1100, 1110, and 1120 may be variously determined. For example, the points 1100, 1110, and 1120 may be determined as a center position of each vehicle or a position where the sensing unit 820 is provided.

In addition, the points 1100, 1110, and 1120 may be determined as a front center portion in the present vehicle, rear center portions in the other vehicles, a front center portion in the present vehicle and the other vehicles, or rear center portions of the present vehicle and the other vehicles.

As such, the locations of the points 1100, 1110, and 1120 may be determined or changed by a user setting.

In this way, the processor 870 may sense (determine, extract, detect) the second position information (i.e., the second position information of the other vehicle) including the relative locations between the present vehicle sensed by the sensing unit 820 and the other vehicles.

In the present invention, the location information of the present vehicle (i.e., location information of the vehicle received through the GPS module 812) may be corrected on the basis of the first position information of the other vehicle received from the other vehicle via the V2X module 814 and the second position information of the other vehicle sensed through the sensing unit 820.

As described above, each of the position information of the vehicle and the first position information of the other vehicle may be GPS information and may have an error range.

The second position information (i.e., the second position information of the other vehicle) sensed by the sensing unit 820 may include distance information between the vehicle 100 and the other vehicle and angle information where the other vehicle is located with respect to one direction (e.g., front direction) of the vehicle 100.

The processor 870 may reduce the error range of the location information of the vehicle 100 using the first position information of the other vehicle acquired by the GPS module of the other vehicle and received via the V2X module 814 and the second position information of the other vehicle sensed through the sensing unit 820.

Hereinafter, a method of reducing an error range of position information of a vehicle using first position information (GPS information) of the other vehicle and second position information (sensed position information) of the other vehicle will be described in detail with reference to the accompanying drawings.

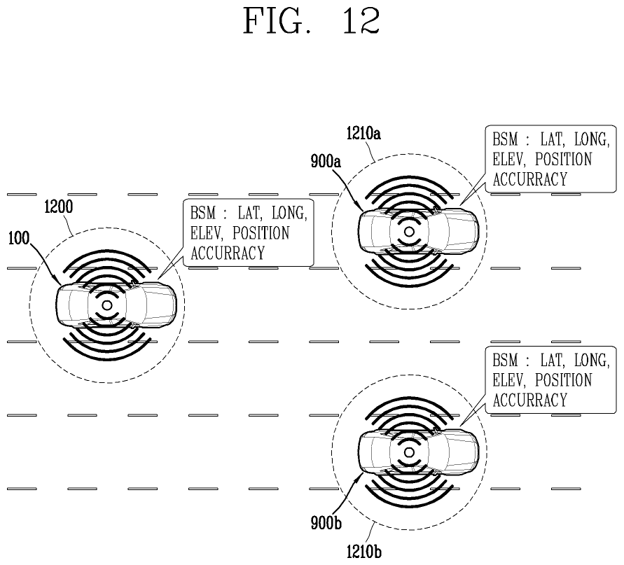

Referring to FIG. 12, the processor 870 may receive position information of the vehicle 100 viewed through the communication unit 810 (GPS module 812). At this time, the position information of the vehicle 100 may have an error range 1200.

Further, the other vehicles 900a and 900b may receive their own position information (first position information of the other vehicles) through the GPS module provided in the other vehicles.

For example, the first vehicle 900a may receive first position information of the first vehicle 900a having an error range 1210a, and the second vehicle 900b may receive first position information of the second vehicle 900b having an error range 1210b.

The processor 870 may receive the first position information of the other vehicles obtained from the other vehicles 900a and 900b through the communication unit 810 (V2X module 814).

At this time, the present vehicle 100 and the other vehicles 900a and 900b may send and receive a message (e.g., beacon messages (BSM, CAM, etc.)) related to the vehicle. The message related to the vehicle may be periodically transmitted and received, and may be transmitted and received with a period of 100 ms, for example.

The first position information of the other vehicle may be included in a message related to the vehicle. That is, when the processor 870 receives a message related to the vehicle from the first other vehicle 900a, the processor 870 may obtain first position information of the first vehicle 900 included in the received message related to the vehicle.

For example, the message related to the vehicle may include at least one of message number information msgCnt, ID information id, time mark information secMark, latitude information lat, longitude information long, altitude information elev, accuracy information, transmission, speed, heading, steering wheel angle information, accelerator setting information accelSet, brake information brakes, vehicle size information, and vehicle color information.

Here, the latitude information, the longitude information, and the altitude information may be acquired through the GPS module. In addition, the error range described in this specification may correspond to the accuracy information. The accuracy information may include a radius of an error range.

In addition, the vehicle size information and the vehicle color information may be included in information related to an appearance of the vehicle (the other vehicle).

When a message related to a vehicle is received from the first and second vehicles 900a and 900b via the V2X module 814, the processor 870 may determine first position information on each of the first and second vehicles 900a and 900b.

At this time, the processor 870 may also determine error ranges 1210a and 1210b for the first position information of the other vehicles.

Through this process, as shown in FIG. 12, the processor 870 may obtain the position information of the vehicle 100 (including the error range 1200) and the first position information (including error ranges 1210a and 1210b) of the other vehicles 900a and 900b.

If the number of the other vehicles 900a and 900b is plural, the first position information of the other vehicle may also be plural.

In the current state, the processor 870 may recognize the fact that the present vehicle 100 and the other vehicles 900a and 900b are within the error ranges 1200, 1210a, and 1210b, respectively, but cannot know accurate positions.

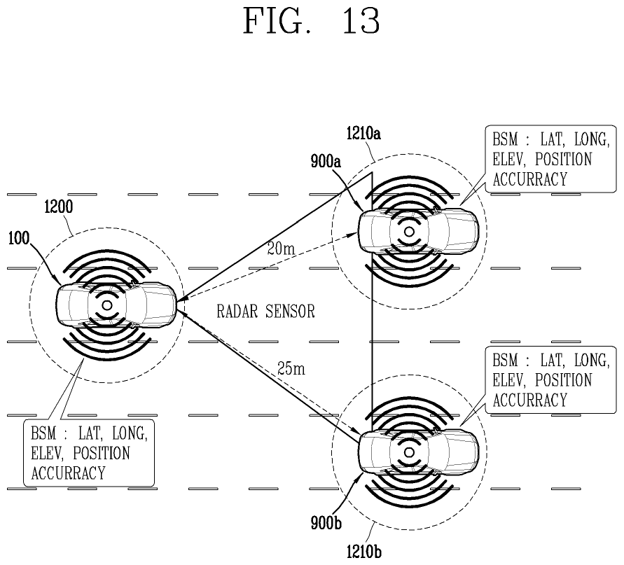

Thereafter, as shown in FIG. 13, the processor 870 may sense second position information including relative positions between the present vehicle 100 and the other vehicles 900a and 900b through (using) the sensing unit 820.

That is, as shown in FIG. 13, the processor 870 may sense the other vehicles 900a and 900b through the sensing unit 820 and acquire second position information of the sensed other vehicles 900a and 900b. The second position information of the other vehicles may include distances to positions where the other vehicles 900a and 900b exist on the basis of the present vehicle and angles.

As described above, error ranges of the second position information of the other vehicles sensed through the sensing unit 820 may be so small as to be neglected due to technological development of the sensor. Accordingly, in this specification, it is assumed that the second position information of the other vehicle sensed through the sensing unit 820 has no error range.

If the number of the other vehicles 900a and 900b is plural, the second position information of the other vehicles may be plural.

The processor 870 may associate the first position information of the other vehicles received through the communication unit 810 (V2X module 814) with the second position information of the other vehicles sensed through the sensing unit 820.

Specifically, the first position information of the other vehicle (or the information related to the other vehicle) may include at least one of information related to a speed of the other vehicle and an appearance of the other vehicle. The information related to the speed of the other vehicle and the appearance of the other vehicle may be included in information related to the vehicle received from the other vehicle via the V2X module 814.

The information related to the appearance of the other vehicle may include at least one of vehicle size information (size) or vehicle color information (color).

The processor 870 may associate the first position information of the other vehicle, the second position information of the other vehicle, and the other vehicle on the basis of at least one of the information related to the other vehicle sensed through the sensing unit 820 and the information related to the speed of the other vehicle and the appearance of the other vehicle included in the received first position information of the other vehicle.

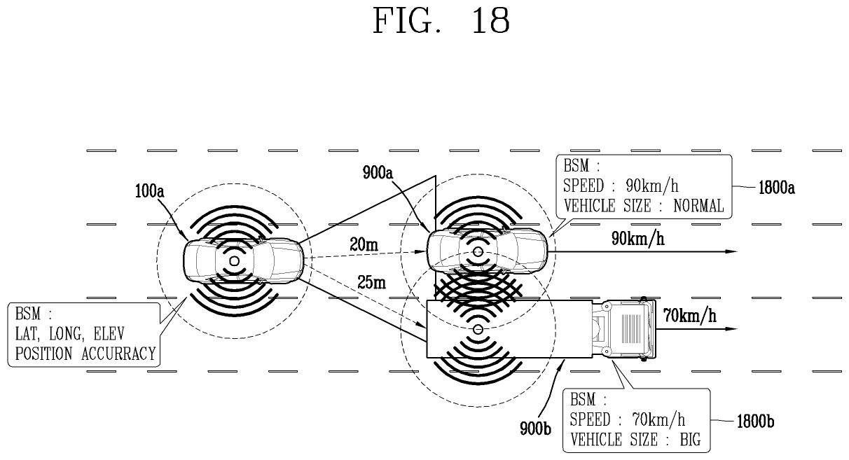

For example, as shown in FIG. 18, the first position information (or the information related to the vehicle) received from the first other vehicle 900a may include information (normal size) related to a speed (90 km/h) and appearance of the first vehicle 900a. The processor 870 may determine that the other vehicle having the speed of 90 km/h and the normal size is the first vehicle 900a, among the other vehicles 900a and 900b sensed through the sensing unit 820.

The processor 870 may associate the first position information received from the first vehicle 900a, the second position information of the first vehicle 900a sensed through the sensing unit 820 (that is, the second position information including the relative position between the present vehicle and the first vehicle 900a), and the first vehicle 900a.

As another example, for example, as shown in FIG. 18, the first position information (or the information related to the vehicle) received from the second vehicle 900b may include information (large size) related to a speed (70 km/h) and an appearance (large size) of the second other vehicle 900b. The processor 870 may determine that the other vehicle having the speed 70 km/h and the large size is the second other vehicle 900b among the other vehicles 900a and 900b sensed through the sensing unit 820.

The processor 870 may associate the first position information received from the second vehicle 900b, the second position information of the second vehicle 900b sensed through the sensing unit 820 (that is, the second position information including the relative position between the present vehicle and the second vehicle 900b), and the second vehicle 900a.

The processor 870 may also sense the relative position (distance) between the other vehicles 900a and 900b through the sensing unit 820.

Referring back to FIG. 13, the processor 870 may correct the position information of the present vehicle on the basis of the three pieces of position information (location information of the present vehicle the first position information of the other vehicles) having an error range and the absolute distance (the second position information of the other vehicle) between the present vehicle and the other vehicles 900a and 900b.

Specifically, the processor 870 may reduce the error range of the position information of the vehicle 100 by using the first position information (GPS information) of the other vehicle and the second position information (absolute distance) of the other vehicle.

For example, when the processor 870 knows the GPS information (the position information of the present vehicle and the first position information of the other vehicle) of a plurality of vehicles and the relative position (absolute distance, angle) between the plurality of vehicles, the processor 870 may reduce an error range of the GPS information of the plurality of vehicles by applying a preset algorithm.

For the preset algorithm, the following equation 1 may be used.

$$( \begin{matrix}{x}_{G 1 new} \\ {y}_{G 1 new} \\ {x}_{G 2 new} \\ {y}_{G 2 new} \\ {x}_{G 3 new} \\ {y}_{G 3 new}\end{matrix} ) = ( \begin{matrix}{x}_{R 1} & {y}_{R 1} & 1 & 0 \\ - {x}_{R 1} & {y}_{R 1} & 0 & 1 \\ {x}_{R 2} & {y}_{R 2} & 1 & 0 \\ - {x}_{R 2} & {y}_{R 2} & 0 & 1 \\ {x}_{R 3} & {y}_{R 3} & 1 & 0 \\ - {x}_{R 3} & {y}_{R 3} & 0 & 1\end{matrix} ) \times ( \begin{matrix}cos Δθ \\ sin Δ θ \\ \frac{{x}_{G 1} + {x}_{G 2} + {x}_{G 3}}{3} \\ \frac{{y}_{G 1} + {y}_{G 2} + {y}_{G 3}}{3}\end{matrix} ) \qquad [ Equation 1 ]$$

Here, Δθ may be expressed by the following equation 2.

$$Δθ = \frac{{θ}_{1} + {θ}_{2} + {θ}_{3}}{3} \qquad [ Equation 2 ]$$

θ_1, θ_2, θ_3 may refer to an angle between the present vehicle and the other vehicles, X_G1 and y_G1 may be position information of the present vehicle before correction, x_G2 and y_G2 may be first position information of the first other vehicle before correction, x_G3, and y_G3 may be first position information of the second other vehicle before correction.

X_R1, y_R1, . . . , y_R3 are relative coordinates between the present vehicle and the other vehicles. The relative coordinates, which indicate relative positions as coordinates, may be measured through the sensing unit 820.

X_G1new and yG1new may be corrected positional coordinates of the present vehicle 100, x_G2new and y_G2new may be corrected first position information of the first vehicle, and x_G3new and y_G3new may be corrected first position information of the second vehicle.

In order to apply the above algorithm, a minimum of three vehicles are required. Thus, in the present invention, the position information of the present vehicle may be corrected using the first other vehicle and the second other vehicle. In addition, when the position information of the present vehicle is corrected, the first position information of the other vehicles may also be corrected. This may be performed through the above algorithm or may be performed using the second position information (absolute distance, angle) of the other vehicle in the corrected position information of the present vehicle.

In this specification, correcting the position information of the present vehicle may include the meaning of reducing the error range of the position information of the present vehicle.

Applying the above algorithm, the error range of the position information may be reduced to 0.6 m when the error range of the position information received by one GPS is 20 m.

That is, the present invention may have the effect of using a plurality of GPS modules by receiving the GPS information (i.e., the first position information of the other vehicle) received (acquired) from the other vehicle.

Meanwhile, when the above algorithm is applied, if the error range of the position information of the present vehicle is equal to the error range of the first position information of the other vehicle or if the error range of the first position information of the other vehicle is larger than the error range of the position information of the present vehicle, the processor 870 may correct the position information of the vehicle.

The processor 870 may newly receive the first position information of the other vehicle from the other vehicle according to the passage of time and newly detect the second position information of the other vehicle through the sensing unit 820. That is, the processor 870 updates the position information of the present vehicle by applying the first and second position information which are newly received and newly sensed.

That is, the processor 870 may reduce the error range of the position information of the present vehicle over time.

However, the present invention is not limited thereto, and the error range of the position information of the vehicle and the error range of the first position information of the other vehicle may be different from each other.

For example, the error range of the position information of the vehicle 100 may be larger than the error range of the first position information of the other vehicle. That is, the fact that the error range of the first position information of the other vehicle is smaller than the error range of the position information of the vehicle 100 may mean that accuracy of the first position information of the other vehicle is better than accuracy of the position information of the present vehicle.

In this case, the processor 870 may correct the position of the present vehicle on the basis of second position information (absolute distance, angle) of the other vehicle sensed through the sensing unit 820 and the first position information of the other vehicle having an error range smaller than the error range of the position information of the present vehicle.

If the error range of the first position information of the other vehicle is smaller than the error range of the position information of the present vehicle, the position information of the present vehicle may be corrected more quickly and accurately.

As described above, correcting the position information of the present vehicle may include the meaning of reducing the error range of the position information of the present vehicle.

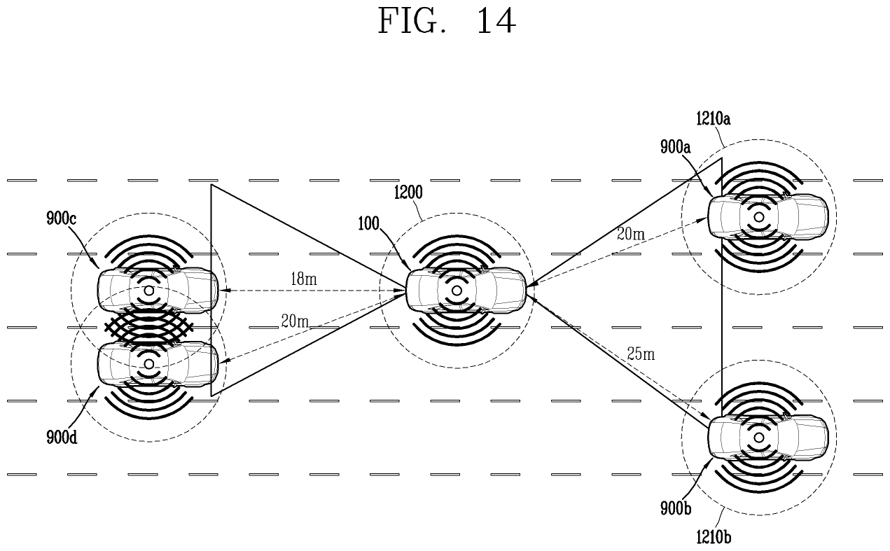

Meanwhile, as shown in FIG. 14, the processor 870 of the present invention may more accurately correct the position information of the vehicle as the number of other vehicles increases.

More specifically, as shown in FIG. 14, the error range of the position information of the vehicle 100 may be further reduced as the second position information (i.e., the other vehicles 900a, 900b, 900c, and 900d) sensed by the sensing unit 820 and the number of the other vehicles 900a, 900b, 900c, and 900d transmitting the first position information increase.

That is, as the number of other vehicles increases (i.e., the sensed other vehicles and first position information received from the sensed other vehicles increase) and as time goes by, the processor 870 of the present invention may further reduce the error range of the position information. That is, the fact that the error range is further reduced may be understood to mean that accuracy of the position information is improved.

Through this configuration, the present invention may provide a control method for more accurately correcting the position of the present vehicle, that is, more accurately positioning the present vehicle, by using the GPS information (first position information) of the other vehicle received from the other vehicle and the absolute distance and angle (second position information) sensed by the sensing unit.

In addition, the processor 870 may reduce the error range of the first position information (GPS information) of the other vehicle on the basis of the position information of the vehicle reduced in the error range and the second position information of the other vehicle sensed through the sensing unit 820. Thereafter, the processor 870 may perform a V2X safety service, ADAS, autonomous driving, and the like on the basis of the position information of the vehicle 100 reduced in the error range and the first position information of the other vehicle (or the second position information of the other vehicle).

The processor 870 may also transmit the first position information of the other vehicle with the reduced error range to the other vehicle.

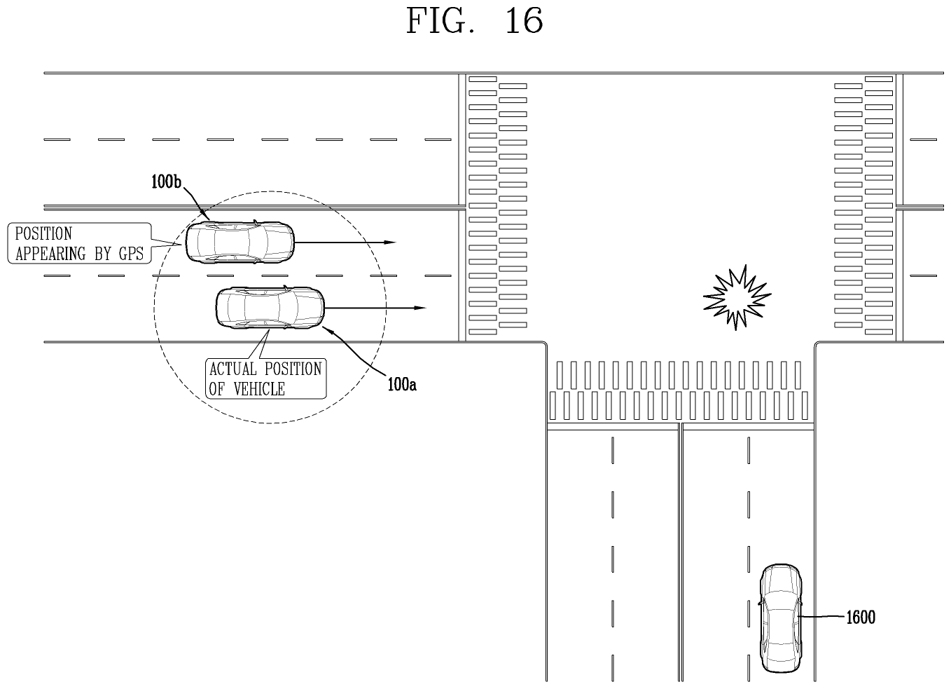

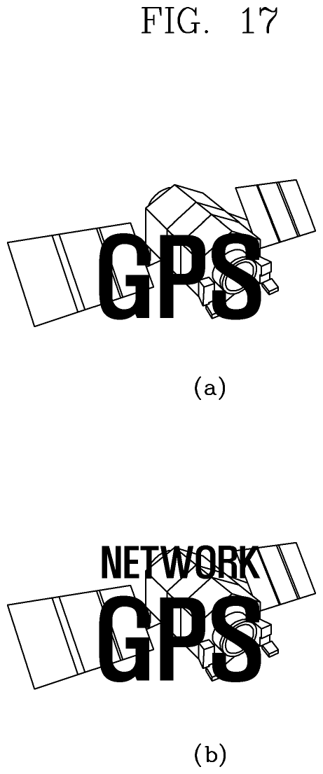

Meanwhile, as shown in FIG. 16, the processor 870 may identify a lane of a road in which the vehicle 100 is running, on the basis of the corrected position information of the vehicle.

As described above, the processor 870 may reduce the error range to within 0.6 m by applying the position information of the present vehicle, the first position information of the other vehicle, and the second position information of the other vehicle to the preset algorithm.

Accordingly, the processor 870 may identify the lane in which the present vehicle 100a is running.

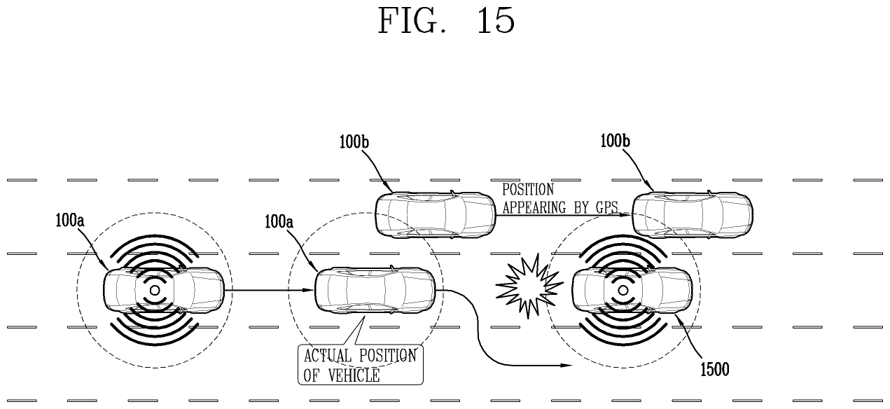

Referring to FIG. 15, if the error range of the position information of the present vehicle is large, the processor 870 may determine that the vehicle 100b is in a second lane even though the actual position of the vehicle 100a is in the first lane.

At this time, since there is no preceding vehicle in the second lane, the processor 870 may not perform a separate ADAS function (e.g., forward collision warning).

However, if the lane in which the actual vehicle 100a is running is the first lane and the other vehicle 1500 exists in the first lane, there is a risk of collision.

Accordingly, the processor 870 of the present invention may correctly identify the lane in which the current vehicle 100a is running by reducing the error range of the position information of the present vehicle, and on the basis of this, the processor 870 may calculate a possibility of collision with the other vehicle 1500.

Also, as shown in FIG. 16, the processor 870 may determine a collision anticipated point with the other vehicle 1600 on the basis of the corrected position information of the vehicle (that is, the position information of the present vehicle with the reduced error range) and the second position information sensed by the sensing unit 820.

If the error range is large (i.e., if the position information of the present vehicle is not corrected), the collision anticipated point with the other vehicle 1600 is different.

That is, the processor 870 may determine a collision anticipated point with the other vehicle 1600 on the basis of the position information of the vehicle 100a corrected to reduce the error range.

Thereafter, the processor 870 may perform the ADAS function (AEB, FCW, etc.) on the basis of the collision anticipated point and the driving state (e.g., speed and deceleration state) of the vehicle.

Meanwhile, as shown in (a) of FIG. 17, when the processor 870 simply receives the position information of the vehicle 100 through the GPS, a first icon may be output to the display unit.

Meanwhile, as shown in (b) of FIG. 17, when the position information of the vehicle 100 is received via the GPS module, the first position information of the other vehicle is received via the V2X module, the second position information of the other vehicle is sensed through the sensing unit 820, and an operation of correcting the position information of the present vehicle is performed on the basis of the first and second position information, a second icon different from the first icon may be output to the display unit.

The display unit may include the display unit 251 provided in the vehicle or the display unit of a mobile terminal owned by an occupant of the vehicle.

As described above, the vehicle control device of the present invention may correct the position information of the present vehicle using a plurality of pieces of position information obtained through a plurality of GPS modules provided in a plurality of vehicles and a relative position (absolute distance, angle, etc.) between the plurality of vehicles.

This configuration is not limited to the plurality of vehicles but may be applied to all devices capable of receiving GPS information. For example, the mobile terminal may be provided with a GPS module, and each of the mobile terminals may receive position information (GPS information).

In addition, the sensing unit 820 may sense relative positions (corresponding to the second position information described above) of the mobile terminals located in the vehicle, on the basis of one point of the vehicle.

That is, the vehicle control device of the present invention may correct the position information of the present vehicle using the mobile terminal.

Hereinafter, various methods of correcting position information of a vehicle according to the present invention will be described in detail with reference to the accompanying drawings.

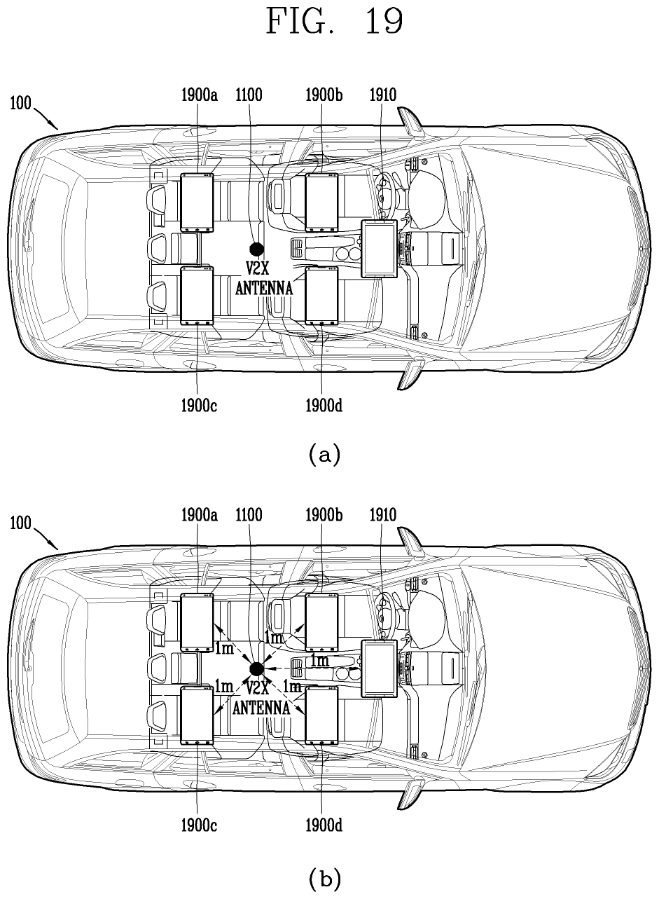

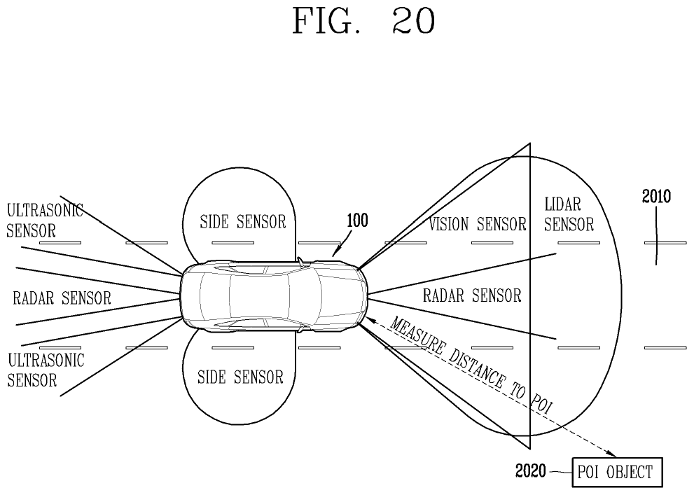

FIGS. 19 and 20 are conceptual diagrams illustrating a control method for correcting position information of the present vehicle according to another embodiment of the present invention.

Referring to FIG. 19, the communication unit 810 may receive position information of the mobile terminal from at least one mobile terminal 1900a, 1900b, 1900c, and 1900d existing in the vehicle 100. Preferably, the processor 870 may receive position information of the mobile terminal from at least two mobile terminals.

Meanwhile, the processor 870 may receive position information of a navigation system 1910 from the navigation system 1910 provided in the vehicle. If the navigation system 1910 separately includes a GPS module, the navigation system 191 acquires position information of the navigation system 1910 through the GPS module and transmit the position information of the navigation system 1910 according to a request from the processor 870.

Meanwhile, as shown in (b) of FIG. 19, the processor 870 may sense position information (absolute distance and angle from the one point 1100) including a relative position between the one point 1100 (e.g., point where the V2X antenna is provided) of the vehicle and at least one mobile terminal (or navigation system 1910) existing in the mobile terminal 100.

Generally, the mobile terminals may be located at positions within 1 meter from the one point 1100 of the vehicle.

The processor 870 may correct the position information of the vehicle using the position information (including the error range) of the mobile terminal obtained through the communication unit 810 and the position information (without an error range) including a relative position between one point of the vehicle sensed through the sensing unit 810 and the mobile terminal.

The method of correcting the position information of the vehicle may be performed by the preset algorithm described above.

As described above, in the present invention, the position information of the present vehicle may also be corrected by utilizing a mobile terminal existing in the vehicle.

Also, in this case, when the position information of the present vehicle is corrected, a second icon may be output to the display unit 251 as shown in (b) of FIG. 17.

In addition, the processor 870 may identify a lane of a road in which the vehicle is running by using the sensing unit 820. For example, the processor 870 may store information on a marking drawn for each lane included in map information or receive the information from the Internet or an external server.

The processor 870 may identify the lane of the road in which the vehicle is running on the basis of an image received through the sensing unit 820 (for example, a camera) and the information about the marking drawn for each lane included in the map information.

Thereafter, the processor 870 may correct the position information of the vehicle on the basis of the identified lane.

Meanwhile, as shown in FIG. 20, the processor 870 may sense relative position information between the present vehicle 100 and a preset object using the sensing unit 820. In addition, the processor 870 may correct the position information of the present vehicle 100 on the basis of the absolute coordinates of the preset object and the relative position information with the preset object.

The processor 870 may store the absolute coordinates (absolute position information) of the preset object (interest object) 2020. In addition, the absolute coordinates (absolute position information) of the preset object (interest object) 2020 may be received from the Internet or an external server through the communication unit.

The processor 870 may sense the preset object 2020 through the sensing unit 820. For example, the processor 870 may sense the preset object 2020 on the basis of an image received through a vision sensor (camera) included in the sensing unit 820.

The processor 870 may sense the relative position information (absolute distance, angle) including the relative position between the preset object 2020 and the present vehicle 100 through the sensing unit 820.

Thereafter, the processor 870 may correct the position information of the vehicle on the basis of the absolute coordinates of the preset object 2020 and the relative position information including the relative position between the preset object and the present vehicle. For example, the processor 870 may identify a lane 2010 in which the vehicle is running by correcting the position information of the present vehicle.

According to an embodiment of the present invention, there is one or more of the following effects.

The present invention may provide a vehicle control device and a vehicle control method capable of reducing an error range of position information of the vehicle by an optimized method.

In addition, the present invention may provide a new method for obtaining precise position (coordinates) of the present vehicle, which may be applied to ADAS, V2X service, and autonomous driving, while using a low-cost GPS.

In addition, the present invention may provide a new method for further reducing an error range included in the position information of the present vehicle as the number of other vehicles around the vehicle increases.

In addition, the present invention may provide a system capable of improving accuracy of GPS information of the present vehicle on the basis of position information of the other vehicle measured by the sensor and the GPS information of the surrounding vehicles received through V2X communication.

The effects of the present invention are not limited to the effects mentioned above, and other effects not mentioned may be clearly understood by those skilled in the art from the description of the claims.

The vehicle control device 800 described above may be included in the vehicle 100.

The operation or control method of the vehicle control device 800 described above may be inferred and applied in the same/similar manner as an operation or control method of the vehicle 100 (or the controller 170).

For example, the control method of the vehicle 100 (or the control method of the vehicle control device 800) may include receiving position information of the present vehicle through a GPS module, receiving first position information of the other vehicle from the other vehicle through a V2X module, sensing second position information including a relative position between the present vehicle and the other vehicle through a sensing unit, and correcting position information of the present vehicle on the basis of the first position information and the second position information.

Each of the above steps may be performed not only by the vehicle control device 800 but also by the controller 170 provided in the vehicle 100.

Further, all of the functions, components, or control methods performed by the vehicle control device 800 described above may be performed by the controller 170 provided in the vehicle 100. That is, all the control methods described in this specification may be applied to a control method of a vehicle or a control method of a control device.

The present invention can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the processor or the controller. Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

1. A vehicle control device comprising:
a communication unit receiving position information of the vehicle through a GPS module and receiving first position information of another vehicle through a V2X module from the other vehicle;
a sensing unit sensing second position information including a relative position between the vehicle and the other vehicle; and
a processor correcting the received position information of the vehicle on the basis of the first position information received through the communication unit and the second position information sensed through the sensing unit.

2. The vehicle control device of claim 1, wherein
the position information of the vehicle and the first position information of the other vehicle are GPS information and have an error range.

3. The vehicle control device of claim 2, wherein
the error range of the position information of the vehicle is different from the error range of the first position information of the other vehicle.

4. The vehicle control device of claim 3, wherein
the error range of the position information of the vehicle is larger than the error range of the first position information of the other vehicle.

5. The vehicle control device of claim 1, wherein
the second position information sensed through the sensing unit includes distance information between the vehicle and the other vehicle, and angle information at which the other vehicle is located with respect to distance information between the vehicle and the other vehicle and one direction of the vehicle.

6. The vehicle control device of claim 2, wherein
the processor reduces an error range of the position information of the vehicle using the first position information and the second position information.

7. The vehicle control device of claim 6, wherein
the error range of the position information of the vehicle is further reduced as the sensed second position information and the number of other vehicles that transmit the first position information increase.

8. The vehicle control device of claim 6, wherein
the processor reduces the error range of the first position information on the basis of the position information of the vehicle reduced in the error range and the second position information.

9. The vehicle control device of claim 1, wherein
the processor identifies a lane of a road in which the vehicle is running, on the basis of the corrected position information of the vehicle.

10. The vehicle control device of claim 1, wherein
the processor determines a collision estimated point with the other vehicle on the basis of the corrected vehicle position information and the sensed second position information.

11. The vehicle control device of claim 1, wherein
the first position information of the other vehicle includes at least one of information related to a speed of the other vehicle and information related to an appearance of the other vehicle, and the processor associates the first position information, the second position information, and the other vehicle on the basis of the information related to the other vehicle sensed through the sensing unit and at least one of the information related to the speed of the other vehicle and information related to an appearance of the other vehicle included in the received first position information of the other vehicle.

12. The vehicle control device of claim 1, wherein
the communication unit is configured to receive position information of the mobile terminal from at least one mobile terminal existing in the vehicle, and the processor may be configured to correct the position information of the vehicle using the position information received from the at least one mobile terminal through the communication unit and the position information of the vehicle.

13. The vehicle control device of claim 1, wherein
the processor identifies a lane of a road in which the vehicle is running using the sensing unit, and corrects the position information of the vehicle on the basis of the identified lane.

14. The vehicle control device of claim 1, wherein
the processor senses relative position information between the present vehicle and a preset object using the sensing unit and corrects the position information of the vehicle on the basis of absolute coordinates of the preset object and the relative position information with respect to the preset object.

15. A vehicle comprising the vehicle control device described in claim 1.
